(19) United States
(12) Patent Application Publication
(10) Pub. No.: US 2004/0265684 A1
(43) Pub. Date: Dec. 30, 2004

(54) Electrochemical cell refueling and maintenance system

(76) Inventors: Sadeg M. Faris, Pleasantville, NY (US); Tsepin Tsai, Chappaqua, NY (US)

Correspondence Address: REVEO, INC., 3 WESTCHESTER PLAZA, ELMSFORD, NY, 10523, US

(21) Appl. No.: 10/842,238

(22) Filed: May 10, 2004

Related U.S. Application Data
(60) Provisional application No. 60/469,057, filed on May 8, 2003.

(51) Int. Cl. H01M 10/42

(52) U.S. Cl. 429/61; 429/149

(57) ABSTRACT

A modular electrochemical cell system is provided. The system includes N+X individual electrochemical cell modules. N modules of the system are typically sufficient to provide an electrical discharge output or receive an electrical recharge input. A control system is also provided for detecting the condition of each module and determining the best N modules to provide the function needed for optimal performance during recharge or discharge. The control system may also control switching of the N+X modules. One or more of the extra X modules excluded from the control system determination are available for maintenance or refueling without interruption of the operation of the remaining N modules.

### CROSS-REFERENCE TO RELATED APPLICATIONS

This application claims the benefit under 35 U.S.C. § 119(e) of U.S. Provisional Application No. 60/469,057 filed on May 8, 2003 which is herein incorporated by reference.

### FIELD OF THE INVENTION

The present invention relates to metal air electrochemical cell systems, and particularly to uninterruptible systems that remain uninterrupted during normal refueling and/or maintenances operations.

### BACKGROUND

Metal air electrochemical cells have become attractive as an “alternative alternative energy” source (2001 Electric Vehicle . . . which is incorporated by reference herein in its entirety), primarily due to the very high energy density and the capability of refueling the consumable metal fuel. Energy of metal air cells can be replenished by exchange the used or exhausted metal anode with a fresh anode or fresh anode material. Further, certain types of electrochemical cells may be electrically recharged to electrochemically convert the metal oxide discharge reaction product back into consumable metal fuel. In both cell systems that are electrically rechargeable and those that are not, maintenance is also a common need in proper cell operation (e.g., cleaning of a reusable cathode structure, replacing damaged components, etc.)

An existing disadvantage of the refueling or maintenance processes is the down time of the system. Since the metal air cell can be refueled several times during its usable life, the refueling or maintenance of the metal air cell is necessary in order to extract energy from the cell or system. However, the down time of the system during the refueling process, or during maintenance, is a large overhead for the users. For example, in an uninterrupted power system (UPS) or backup power system using metal air cells as its energy source, the refueling or maintenance time is a high risk if the entire system must be shut down.

Therefore, a need exists in the art to provide a metal air electrochemical cell system that may be operated without interruption (in either discharging mode, or recharging mode in electrically rechargeable cell systems) during refueling and/or maintenance processes.

### SUMMARY

The above-discussed and other problems and deficiencies of the prior art are overcome or alleviated by the several methods and apparatus of the present invention for a modular electrochemical cell system, in particular, a fuel cell battery device and system.

The system includes N+X individual electrochemical cell modules. N modules of the system are typically sufficient to provide an electrical discharge output or receive an electrical charging input. In certain embodiments, a control system is also provided for detecting the condition of each module and determining the best N modules to provide the function needed for optimal performance during charging or discharge. One or more of the extra X modules (excluded from the control system determination when a control system is employed) are available for service or refueling (with or without removal of the cell structure) without interruption of the operation of the remaining N modules.

Therefore, provided herein is a system with the flexibility to continue operation and provide maintenance and/or refueling operations without the need to interrupt discharging or charging of the remaining cells.

The above-discussed and other features and advantages of the present invention will be appreciated and understood by those skilled in the art from the following detailed description and drawings.

### BRIEF DESCRIPTION OF THE DRAWINGS

FIG. 1 depicts a metal air system.

FIG. 2 shows the refueling or maintenance of first metal air module of the system.

FIG. 3 shows the refueling or maintenance of second metal air module of the system.

FIG. 4 depicts the refueling or maintenance of the Nth metal air module of the system.

FIG. 5 shows the refueling or maintenance of the N+1th metal air module of the system.

### DETAILED DESCRIPTION OF THE ILLUSTRATIVE EMBODIMENTS

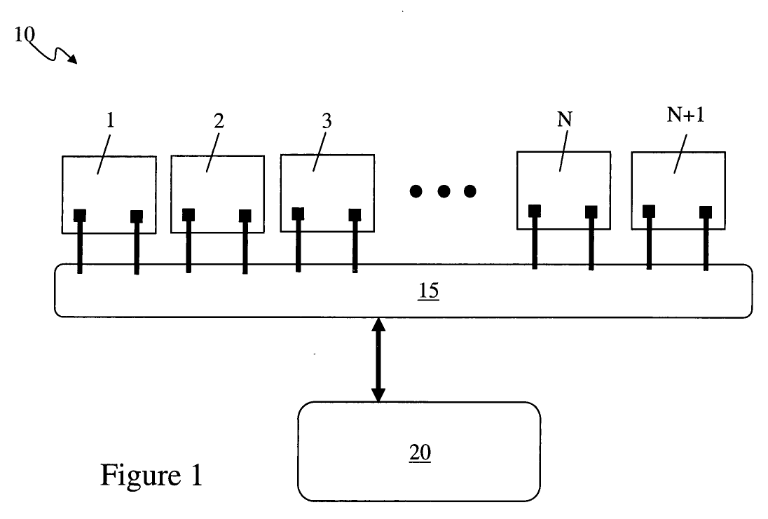

An electrochemical cell system 10 for providing energy needed for various purposes is shown in FIG. 1. The system includes a plurality of electrochemical cells, illustrated as modules 1, 2, 3, . . . N, N+1. Under typical operations of the cell system 10 (discharging, or electrical charging in electrically rechargeable systems), N modules are sufficient. The function of the additional module will be discussed further herein.

The type of electrochemical cell may include metal air electrochemical cells, and in certain embodiments, fuel cell battery devices and systems. A fuel anode is brought into ionic-contact with a cathode structure by way of an ionically-conducting medium (such as an ionically-conducting polymer, an electrolyte gel, or a liquid electrolyte such as KOH or NaOH). An electro-chemical reaction at this interface produces electrical power that is delivered to an electrical power-consuming load device electrically coupled thereto (via an anode terminating element electrically coupled between the anode and the electrical power-consuming load device and a cathode terminating element electrically coupled between the cathode structure and the electrical power-consuming load device). During this electro-chemical reaction, O₂ is typically consumed at the cathode-electrolyte interface of the fuel cell. In metal-air fuel cell battery devices and systems, the fuel anode is a metal (such as zinc or aluminum in the form cards, sheets, tape, paste and the like).

In metal-air fuel cell battery devices and systems, the oxidized metal (such as zinc-oxide or aluminum-oxide) may be charged by connecting a power-generating source across the interface whereby the reverse electro-chemical reaction converts the oxidized metal into its original form suitable for reuse in power discharging operations. The electro-chemistry upon which such discharging and recharging operations are based is described in WO 99/18628, entitled “Metal-Air Fuel Cell Battery Systems Employing Metal-Fuel Cards”, WO 99/18627 entitled “Metal-Air Fuel Cell Battery Systems Employing Metal-Fuel Tape”, WO 99/18620 entitled “Metal-Air Fuel Cell Battery Systems Employing Moving Anode And Cathode Structures”, WO 03/41211 entitled “Rechargeable And Refuelable Metal Air Electrochemical Cell”, WO 02/73732 entitled “Refuelable Metal Air Electrochemical Cell And Refuelable Anode Structure For Electrochemical Cells”, and U.S. Pat. No. 5,250,370, all of which are incorporated herein by reference.

The anode structure (particularly the consumable anode fuel material in metal-air fuel cells) of the fuel cell in such fuel cell battery devices and systems has a limited lifetime. After a number of discharge/recharge cycles, an anode replacement operation is required wherein the anode structure (e.g., oxidized metal in a metal-air fuel cell, or anode element in a hydrogen-based fuel cell) is replaced with a new anode structure.

The cathode structures of the fuel cell battery devices and systems also have a limited lifetime. In metal-air fuel cell battery devices/systems, the cathode structures comprises an oxygen-permeable mesh of inert conductor (e.g., carbon and current collector matrix) and a catalyst for reducing oxygen that diffuses through the mesh into the system. Typically, the operational lifetime of the cathode structure in metal-air fuel cell batteyr devices/systems extends beyond that of a single metal-fuel anode (e.g., 10 to 50 times the operational lifetime), and thus it may be used repeatedly after replacing the corresponding anode. When the operational lifetime of the cathode structure ends, it may be cost effective to replace the “spent” cathode structure.

In addition, the ionic conducting medium (e.g., electrolyte) of the fuel cell battery devices or systems also have a limited lifetime. After a number of discharge/recharge cycles, a replacement operation is required wherein the consumed ionic conducting medium (e.g., electrolyte) is replaced with “fresh” ionic conducting medium for the fuel cell in the fuel cell battery device/system.

Note that in certain embodiments (e.g., as described in more detail in above referenced WO 02/73732), the anode and electrolyte may be replaces in one operation, e.g., wherein the anode card is wrapped with a solid gel membrane, wherein the solid gel membrane serves to electrically separate the anode from cathode, and to provide a source of ionic conducting media.

In other embodiments, a metal air cell may comprise flow type cells, wherein electrode consumable fuel is provided in a liquid or paste form. Such cells may include metal air cells based on metal (e.g., zinc, aluminum) and electrolyte mixture in a paste or liquid form.

Still further, the electrochemical cell may comprise a redox cell such as zinc/bromine, Vanadium redox cell, or other flow based redox cell whereby an anolyte and/or a catholyte are provided in liquid form.

The system 10 may be operably connected to a control system 15 to manage the discharging or charging of a load or charging unit 20. The control system 15 generally includes a sensing system to monitor the condition of each of the individual metal air modules 1, 2, 3 . . . N, N+1 and/or switching systems to electrically connect/disconnect certain cells. The control system 15 may further include a DC to DC converter, DC to AC converter, or suitable intelligence to adjust the system by sensing the outside load demand, depending on sensitivity of the load/charging system to voltage/current level fluctuations. Still further, the control system 15 includes switching systems to switch between series, parallel, or combined series/parallel electrical configurations.

In certain preferred embodiments, the control system comprises an electronic control system incorporating low power semiconductor switches (e.g. transistors or MOSFETs). In further embodiments, a logic system may be coupled to relays or other electro-mechanical switches. In still further embodiments, a switch may include a mechanical or electro-mechanical interlock switch systems, which may be human operated or robotically controlled. The controller may further include or operatively coupled to a power circuit, e.g., comprising one or more capacitors and/or batteries, particularly wherein delays may occur during switch operations and uninterrupted power is required. Note that for parallel cell systems, jumping cells (either via semiconductor switches, mechanical switches or electro-mechanical switches) is typically not required, and in certain embodiments, a control system may not be required when N+X modules are supplied as described herein.

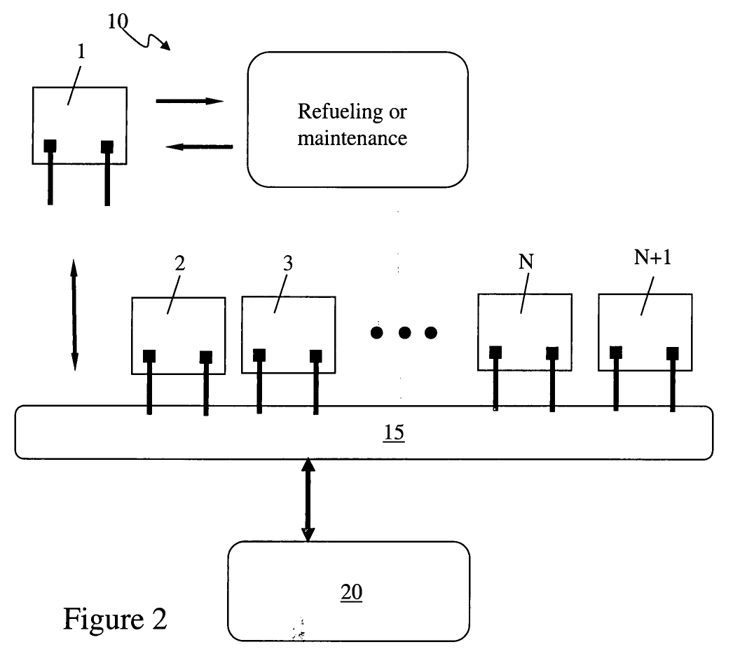

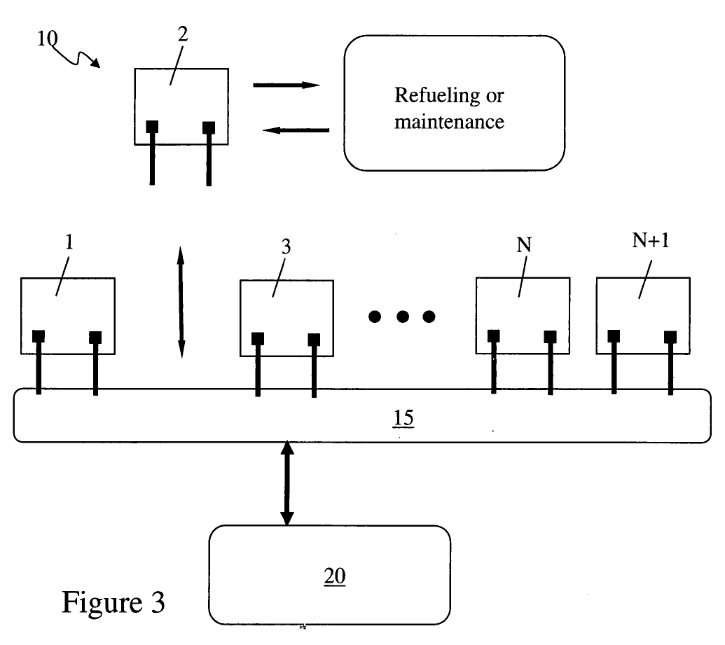

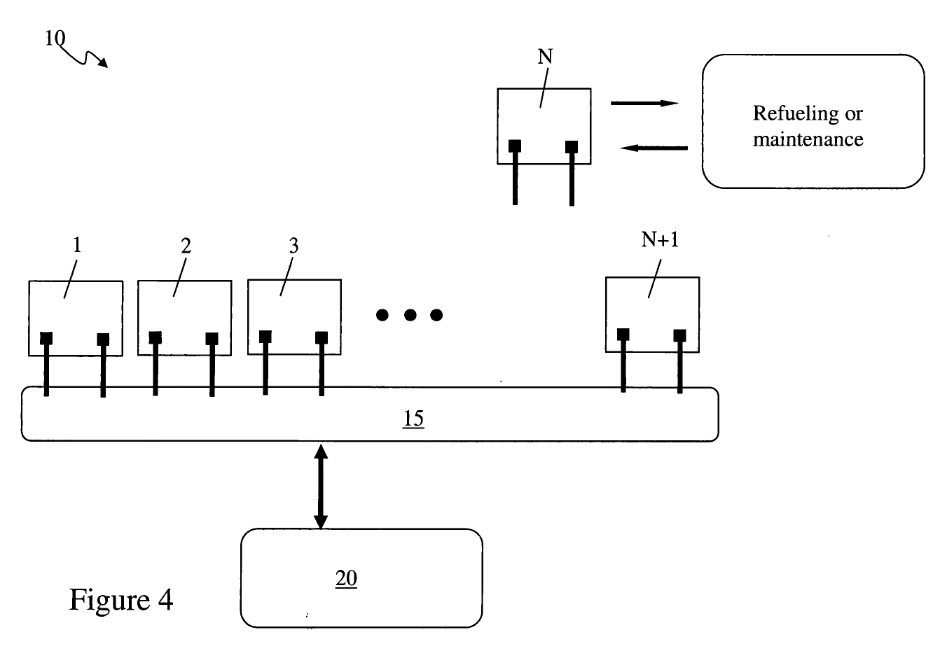

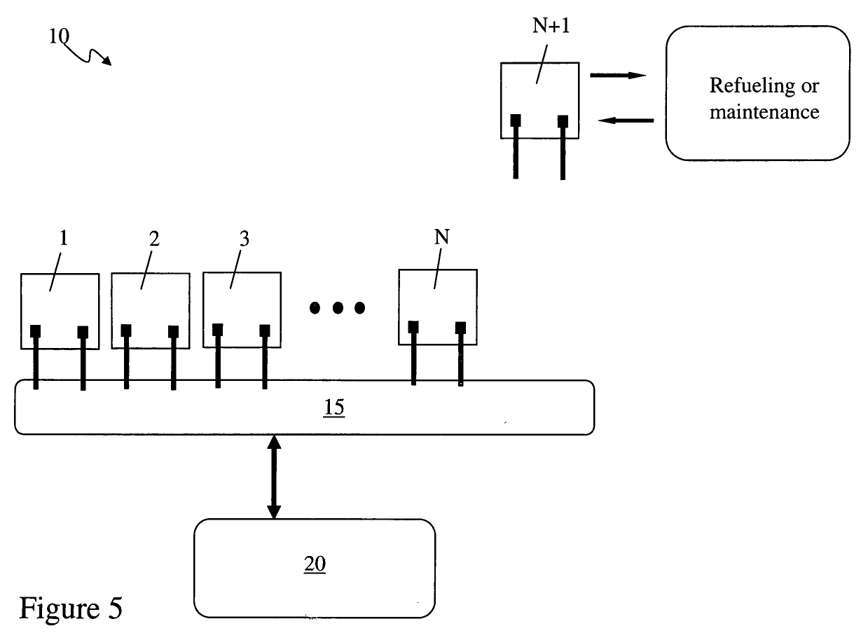

As mentioned above, under typical operations of the cell system 10 (discharging, or electrical charging in electrically rechargeable systems), N modules are sufficient. In certain embodiments, during the normal operation, all the modules (that is, all N+1 modules), may be discharged and/or recharged in unison. In other embodiments, the control system will detect the condition of each module and select the best N modules for discharging or charging, depending on the operational mode of the system. If the refueling or maintenance of one of the modules of the system is needed, the control system detects the condition, whereby module 1 (FIG. 2), module 2 (FIG. 3), module N (FIG. 4), or module N+1 (FIG. 5) may be refueled and/or undergo maintenance. Note that in certain embodiments, this may be accomplished without removal of the entire cell structure. For example, only the consumable anode portion may be removed, wherein the cathode portion remains intact within the cell system, known as mechanical recharging or refueling in the metal air art.

According to an important feature of the present invention, in order to maintain uninterrupted system operation, the refueling and/or maintenance process perform in X modules at a time in the system 10. Thus, N modules still remain for optimal system operation. The N modules remain electrically connected, e.g., via suitable switching systems, bypass jumpers, or other structures, generally under operation of the control system 15 or other suitable switching system.

FIG. 2 shows the first module being disconnected from the system for refueling and/or reconditioning. This refueling or maintenance process can be performed manually or automatically through robotics or other realizable mechanical apparatus. After refueling or maintenance of the first module is completed, the fresh module is returned to the system. As shown in the Figures, the second module may then be made available for refueling and/or maintenance, as shown in FIG. 3. FIGS. 4-5 show refueling and/or conditioning of modules N and N+1.

It should be apparent from the above description that a primary feature of the present invention is to provide one or more extra modules to the system to prevent interruption during the system refueling or maintenance. Thus, although N+1 modules are shown in system 10, which may operate with N modules, N+X modules may be provided, wherein X modules may be made available for refueling and/or conditioning without interruption of the remaining N modules.

The herein described system may be useful in various types of power systems. For example, great benefit may be obtained using the instant system as a UPS (first response), power backup system (second response), or electric vehicle system. Of course, other applications may benefit from the present disclosure, providing a system with the flexibility to continue operation and provide maintenance and/or refueling operations without the need to interrupt discharging or charging of the remaining cells.

While preferred embodiments have been shown and described, various modifications and substitutions may be made thereto without departing from the spirit and scope of the invention. Accordingly, it is to be understood that the present invention has been described by way of illustrations and not limitation.

1. A modular electrochemical cell system comprising:
N+X individual electrochemical cell modules, wherein N modules provide an electrical discharge output or receive an electrical charge input, and
a control system operably connected to the electrochemical cell modules for detecting the condition of each module and determining the best N modules to provide the function needed for optimal performance during charge or discharge;
wherein one or more of the extra X modules excluded from the control system determination are available without interruption of the operation of the remaining N modules, wherein X≧1.

2. A modular electrochemical cell system for providing electrical power comprising:
N+X individual electrochemical cell modules, wherein N modules provide an electrical discharge output, and
a control system operably connected to the electrochemical cell modules for detecting the condition of each module and determining the best N modules to provide the function needed for optimal performance during discharge;
wherein one or more of the extra X modules excluded from the control system determination are available without interruption of the operation of the remaining N modules, wherein X≧1.

3. A modular electrochemical cell system for charging a plurality of electrical cells comprising:
N+X individual electrochemical cell modules, wherein N modules or N+1 modules receive an electrical charge input, and
a control system operably connected to the electrochemical cell modules for detecting the condition of each module and determining if one of the N+X modules is deficient in receiving the electrical charge input;
wherein one or more of the extra X modules excluded from the control system determination are available without interruption of the operation of the remaining N modules, wherein X≧1.

4. A modular electrochemical cell system comprising:
N+X individual electrochemical cell modules, wherein N modules provide an electrical discharge output or receive an electrical charge input, and
a control system operably connected to the electrochemical cell modules for electrically coupling the N modules to a load or charging system;
wherein one or more of the extra X modules are available without interruption of the operation of the remaining N modules, wherein X≧1.

5. A modular electrochemical cell system comprising:
N+X individual electrochemical cell modules electrically connected in series, wherein N modules provide an electrical discharge output or receive an electrical charge input, and
a control system operably connected to the electrochemical cell modules for electrically coupling the N modules to a load or charging system;
wherein one or more of the extra X modules are available without interruption of the operation of the remaining N modules, wherein X≧1.

6. A modular electrochemical cell system comprising:
N+X individual electrochemical cell modules electrically connected in series, wherein N modules provide an electrical discharge output or receive an electrical charge input, and
a control system operably connected to the electrochemical cell modules for determining an ideal N modules of the N+X modules for operation and electrically coupling the determined N modules to a load or charging system;
wherein one or more of the extra X modules are available without interruption of the operation of the determined N modules, wherein X≧1.

7. A modular electrochemical cell system comprising:
N+X individual electrochemical cell modules electrically connected in parallel to a load or charging unit, wherein N modules provide an electrical discharge output or receive an electrical recharge input,
wherein one or more of the extra X modules are available without interruption of the operation of the remaining N modules, wherein X≧1.

8. The system as in claim 1, wherein the extra X modules are available for the purpose of maintenance of the module.

9. The system as in claim 1, wherein the extra X modules are available for the purpose of replacement of the module.

10. The system as in claim 1, wherein each of the modules comprise metal air electrochemical cells.

11. The system as in claim 1, wherein each of the modules comprise refuelable metal air electrochemical cells.

12. The system as in claim 1, wherein each of the modules comprises rechargeable metal air electrochemical cells.

13. The system as in claim 2, wherein the extra X modules are available for the purpose of maintenance of the module.

14. The system as in claim 2, wherein the extra X modules are available for the purpose of replacement of the module.

15. The system as in claim 2, wherein each of the modules comprise metal air electrochemical cells.

16. The system as in claim 2, wherein each of the modules comprise refuelable metal air electrochemical cells.

17. The system as in claim 2, wherein each of the modules comprises rechargeable metal air electrochemical cells.

18. The system as in claim 3, wherein the extra X modules are available for the purpose of maintenance of the module.

19. The system as in claim 3, wherein the extra X modules are available for the purpose of replacement of the module.

20. The system as in claim 3, wherein each of the modules comprise metal air electrochemical cells.

21. The system as in claim 3, wherein each of the modules comprise refuelable metal air electrochemical cells.

22. The system as in claim 3, wherein each of the modules comprises rechargeable metal air electrochemical cells.

23. The system as in claim 4, wherein the extra X modules are available for the purpose of maintenance of the module.

24. The system as in claim 4, wherein the extra X modules are available for the purpose of replacement of the module.

25. The system as in claim 4, wherein each of the modules comprise metal air electrochemical cells.

26. The system as in claim 4, wherein each of the modules comprise refuelable metal air electrochemical cells.

27. The system as in claim 4, wherein each of the modules comprises rechargeable metal air electrochemical cells.

28. The system as in claim 5, wherein the extra X modules are available for the purpose of maintenance of the module.

29. The system as in claim 5, wherein the extra X modules are available for the purpose of replacement of the module.

30. The system as in claim 5, wherein each of the modules comprise metal air electrochemical cells.

31. The system as in claim 5, wherein each of the modules comprise refuelable metal air electrochemical cells.

32. The system as in claim 5, wherein each of the modules comprises rechargeable metal air electrochemical cells.

33. The system as in claim 6, wherein the extra X modules are available for the purpose of maintenance of the module.

34. The system as in claim 6, wherein the extra X modules are available for the purpose of replacement of the module.

35. The system as in claim 6, wherein each of the modules comprise metal air electrochemical cells.

36. The system as in claim 6, wherein each of the modules comprise refuelable metal air electrochemical cells.

37. The system as in claim 6, wherein each of the modules comprises rechargeable metal air electrochemical cells.

38. The system as in claim 7, wherein the extra X modules are available for the purpose of maintenance of the module.

39. The system as in claim 7, wherein the extra X modules are available for the purpose of replacement of the module.

40. The system as in claim 7, wherein each of the modules comprise metal air electrochemical cells.

41. The system as in claim 7, wherein each of the modules comprise refuelable metal air electrochemical cells.

42. The system as in claim 7, wherein each of the modules comprises rechargeable metal air electrochemical cells.
